(19) United States
(12) Patent Application Publication
(10) Pub. No.: US 2016/0337740 A1
(43) Pub. Date: Nov. 17, 2016

(54) CORD COILING DEVICE AND PROTECTION CASE OF ELECTRONIC DEVICE HAVING THE SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHEN-CHING CHU, New Taipei (TW); YU-NING WANG, New Taipei (TW); XIAO-HONG RUAN, Shenzhen (CN)

(21) Appl. No.: 14/805,960

(22) Filed: Jul. 22, 2015

(30) Foreign Application Priority Data
May 11, 2015 (CN) 201510235431.0

(51) Int. Cl. H04R 1/10; B65H 75/44

(52) U.S. Cl. CPC H04R 1/1033; B65H 75/4481; B65H 75/4442; B65H 2701/34

(57) ABSTRACT

A cord coiling device for coiling a headphone cord is provided. The cord coiling device includes a body, a fixing pillar accommodated in the body, a deceleration gear accommodated in an accommodation cavity, a plurality of first magnets set on a first bottom side of the body, and a plurality of second magnets set on the deceleration gear. The body and the deceleration gear stand stable under an attraction force between the first magnets and second magnets, the deceleration gear rotates under a external force, then the body rotates to coil the headphone cord; when a headphone is stuck, the headphone cord is strained and applies a pulling force to the body to stop the body, the body stops rotating and the deceleration gear continues rotating under the external force. An electronic device having the cord coiling device is also provided.

### CROSS-REFERENCE TO RELATED APPLICATIONS

This application claims priority to Chinese Patent Application No. 201510235431.0 filed on May 11, 2015, the contents of which are incorporated by reference herein.

### FIELD

The subject matter herein generally relates to protection case of electronic device.

### BACKGROUND

Electronic devices can be received in protection cases. In some configurations, the electronic devices can be configured to communicate with peripheral devices. Some of the peripheral devices can include a cord.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of a cord coiling device, in a first view.

FIG. 2 is an isometric view of the cord coiling device of FIG. 1, in a second view.

FIG. 3 is a top view of the cord coiling device of FIG. 1.

FIG. 4 is a diagrammatic view of a protection case having the cord coiling device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The present disclosure is described in relation to a cord coiling device for coiling a headphone cord. The cord coiling device comprises a body, a fixing pillar accommodated in the body, a deceleration gear received in an accommodation cavity, a plurality of first magnets set on a first bottom side of the body, and a plurality of second magnets set on the deceleration gear. The body and the deceleration gear remain stable under an attraction force between the first magnets and second magnets, the deceleration gear rotates under a external force, then the body rotates to coil the headphone cord; when a headphone is stuck, the headphone cord is strained and applies a puling force to the body to stop the body, the body stops rotating and the deceleration gear continues rotating under the external force. An electronic device having the cord coiling device is also provided.

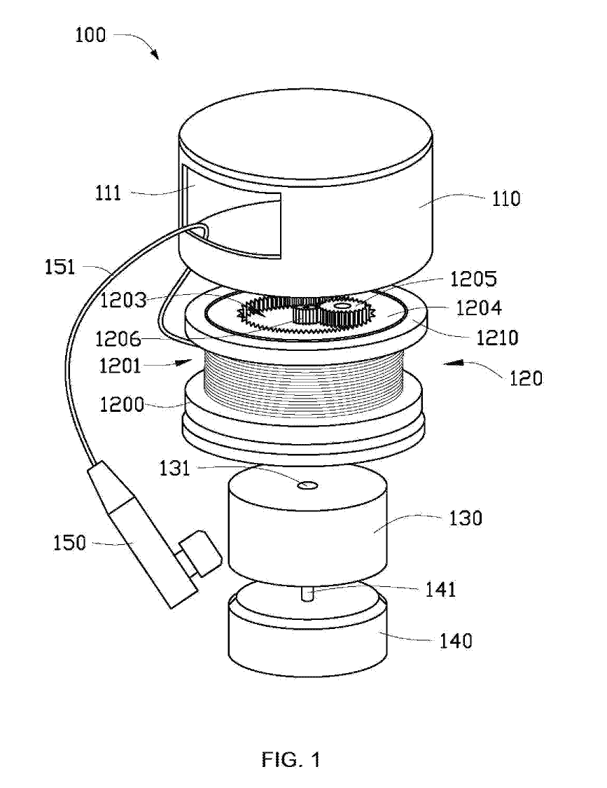

FIG. 1 illustrates an exemplary embodiment of a cord coiling device 100. The cord coiling device 100 can include a housing 110, a coiling reel 120 and a fixing pillar 130. In at least one embodiment, the cord coiling device 100 further includes a motor 140 fixed on the fixing pillar 130, the motor 140 provides a force to drive the coiling reel 120. In an alternative embodiment, the force can be provided by a coil spring or other driving apparatus.

The coiling reel 120 and the fixing pillar 130 are accommodated in the housing 110. An opening 111 is defined on a sidewall of the housing 110 for a headphone cord 151 to pass through. In at least one embodiment, the fixing pillar 130 is fixed in the housing 110. In an alternative embodiment, the fixing pillar 130 can be fixed in an electronic apparatus.

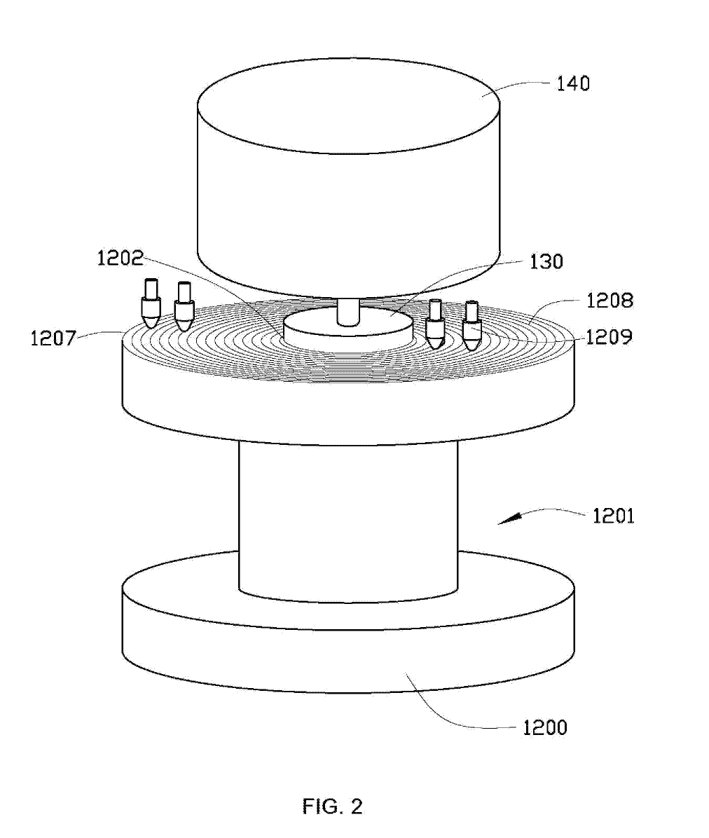

The coiling reel 120 can include a body 1200 and a number of gears. A groove 1201 for accommodating the headphone cord 151 is defined on the body 1200. The body 1200 can define an accommodation cavity 1202 (see FIG. 2) which passes through two bottom sides of the body 1200. The fixing pillar 130 is rotatable and accommodated in the accommodation cavity 1202. When the fixing pillar 130 is accommodated in the accommodation cavity 1202, an accommodation groove 1203 is formed between a bottom side of the fixing pillar 130 and an inner sidewall of the accommodation cavity 1202. The gears are rotatable and accommodated in the accommodation groove 1203.

The gears can include a deceleration gear 1204, a transmission gear 1205 and a driving gear 1206. The motor 140 can include a rotation pole 141. The rotation pole 141 passes through a through hole 131 defined on the fixing pillar 130 and is coupled to the driving gear 1206 to drive the driving gear 1206. The driving gear 1206 and the transmission gear 1205 are fixed in the deceleration gear 1204. The transmission gear 1205 is placed between the deceleration gear 1204 and the driving gear 1206. The transmission gear 1205 is further engaged with the deceleration gear 1204 and the driving gear 1206 to drive the deceleration gear 1204.

FIG. 2 illustrates a number of circle shaped metal pieces 1208 are arranged on a first bottom side 1207 of the body 1200. The metal pieces 1208 have a same center and equal spaces between each other. A number of signal poles 1209 are slidably connected to the metal pieces 1208 and electrically connected to the metal pieces 1208 respectively. The signal poles 1209 are also connected to an audio signal source (not shown) of an electronic apparatus. The headphone cord 151 can include a number of wires (not shown). The wires connect the metal pieces to a headphone 150 (see FIG. 1). Then, audio signals from the audio signal source can be transmitted to the headphone 150 through the metal pieces 1208 and signal poles 1209. In at least one embodiment, the motor 140 is located outside of the body 1200. In an alternative embodiment, the motor 140 can be accommodated into the body 1200 to decrease a size of the coiling device 100.

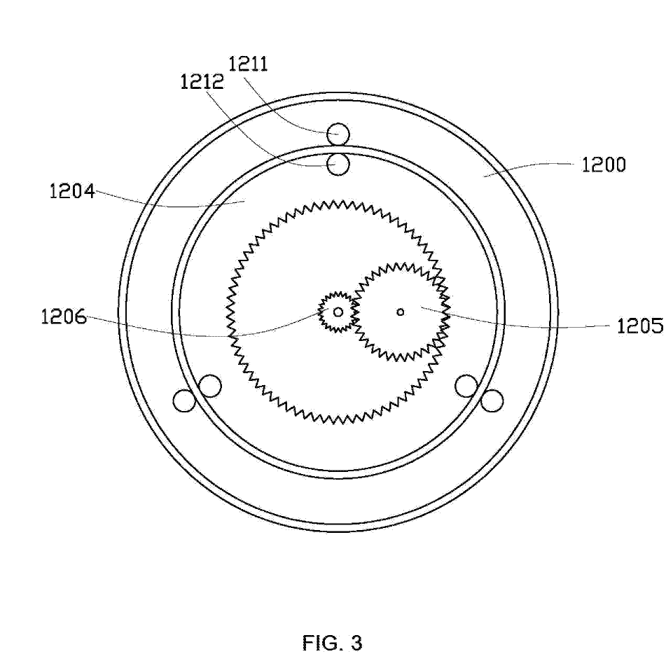

FIG. 3 illustrates that a number of first magnets 1211 are set on a second bottom side 1210 (see FIG. 1) corresponding to the first bottom side 1207 (see FIG. 2). A number of second magnets 1212 are also set on the deceleration gear 1204. The first magnets 1211 attract the second magnets 1212 when approaching each other. In at least one embodiment, the first magnets 1211 and second magnets 1212 are all permanent magnets and the number of the first magnets 1211 and the second magnets each number three. In an alternative embodiment, the number and position of the first magnets 1211 can be adjusted based on actual needs, and the number and position of the second magnets 1212 can also be adjusted.

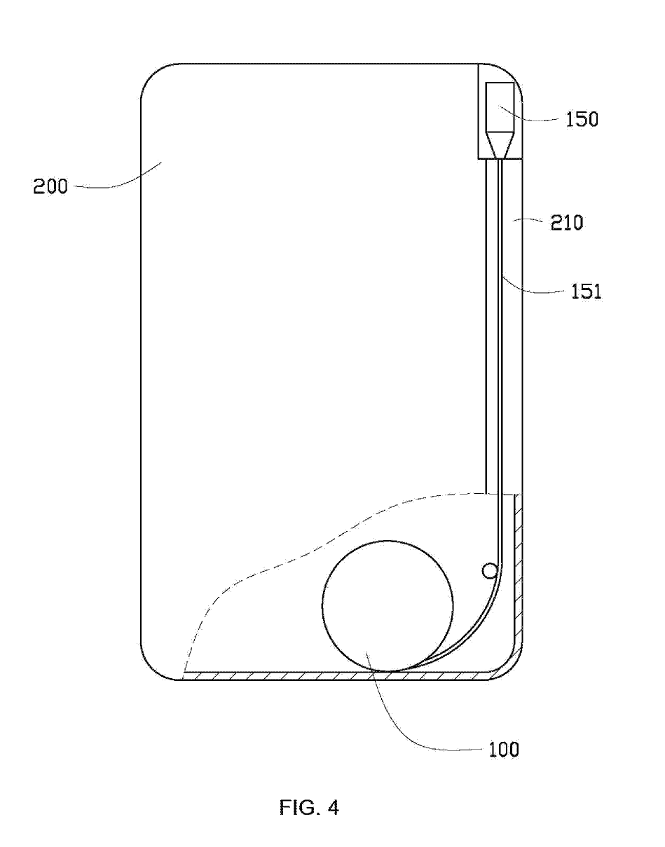

FIG. 4 illustrates the cord coiling device 100 installed inside a protection case 200. The protection case 200 defines an accommodation groove 210 configured to accommodate the headphone 150 and headphone cord 151. The headphone 150 and at least a portion of the headphone cord 151 can be pulled out from the cord coiling device 100 and accommodated in the accommodation groove 210.

When coiling the cord, a user actuates a switch, such as a switch set on the headphone 150, to start the motor 140. The rotation pole 141 of the motor 140 drives the driving gear 1206 to rotate. Then the driving gear 1206 drives the transmission gear 1205, and the transmission gear 1205 drives the deceleration gear 1204. The body 1200 and the deceleration gear 1204 can stand stably under an attraction force between the first magnets 1211 and second magnets 1212. The body 1200 then rotates to coil the headphone cord 151.

When the coiling is finished, the headphone 150 is locked in the accommodation groove 210. Then the headphone cord 151 is strained and applies a pulling force to the body 1200 to stop the body 1200. A torque of the pulling force can be greater than a torque of the attraction force between the first magnets 1211 and second magnets 1212, thereby causing the body 1200 to stop. The deceleration gear 1204 continues rotating under the drive of the transmission gear 1205. The deceleration gear 1204 can continue rotating for a short time period, then the motor 140 stops activating and the deceleration gear 1204 to stop rotating. The body 1200 and the deceleration gear 1204 can stand stable under the attraction force between the first magnets 1211 and second magnets 1212.

The embodiments shown and described above are only examples. Many details are often found in the art such as the other features of a protection case. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. A cord coiling device comprising:
a body defining a groove thereon and having an inside wall, the groove configured to accommodate a headphone cord which is coupled to a headphone;
a fixing pillar located in the body, the fixing pillar comprising a bottom side;
an accommodate cavity defined between the inside wall of the body and the bottom side of the fixing pillar;
a deceleration gear located in the accommodation cavity and being rotatabely fixed on the bottom side of the fixing pillar;
a plurality of first magnets coupled to a first bottom side of the body; and
a plurality of second magnets coupled to the deceleration gear, the plurality of first magnets configured to attract the plurality of second magnets;
wherein the body and the deceleration gear remain stable under an attraction force between the plurality of first magnets and the plurality of second magnets; the deceleration gear rotates under an external force; the body rotates to coil the headphone cord under a drive of the deceleration gear; when a headphone coupled to the headphone cord is stuck, the headphone cord is strained and applies a pulling force to the body to stop the body, the body stops rotating and the deceleration gear continues rotating under the external force.

2. The cord coiling device of claim 1, wherein a torque of the pulling force is greater than a torque of the attraction force between the first plurality of magnets and the plurality of second magnets.

3. The cord coiling device of claim 1, wherein the cord coiling device further comprises a driving gear and a transmission gear, both the driving gear and the transmission gear are rotatablely fixed on the fixing pillar, the driving gear rotates under a driving force of a motor, and the transmission gear is fixed between the driving gear and the deceleration gear to transmit the driving force to the deceleration gear.

4. The cord coiling device of claim 1, wherein a plurality of circle shaped metal pieces are arranged on a second bottom side, corresponding to the first bottom side, of the body, an end of the headphone cord is coupled to the headphone, and the other end is coupled to the plurality of metal pieces.

5. The cord coiling device of claim 4, wherein the cord coiling device further comprises a plurality of signal poles, an end of each signal pole is slidably coupled to one of the plurality of metal pieces, the other end of each signal pole is coupled to an audio signal source.

6. A protection case for an electronic device comprising:
a cord coiling device for coiling a headphone cord, wherein the cord coiling device comprises:
a body;
a groove defined on the body for accommodating a headphone cord;
a fixing pillar accommodated in the body;
a deceleration gear accommodated in an accommodation cavity, the accommodation cavity being defined between a inside wall of the body and a bottom side of the fixing pillar, the deceleration gear being rotatabely fixed on the bottom side of the fixing pillar;
a plurality of first magnets set on a first bottom side of the body; and
a plurality of second magnets set on the deceleration gear, the plurality of first magnets attract the plurality of second magnets;
wherein the body and the deceleration gear stand stable under an attraction force between the plurality of first magnets and the plurality of second magnets, the deceleration gear rotates under an external force, the body rotates to coil the headphone cord under a drive of the deceleration gear; when a headphone coupled to the headphone cord is stuck, the headphone cord is strained and applies a pulling force to the body to stop the body, the body stops rotating and the deceleration gear continues rotating under the external force.

7. The protection case of claim 6, wherein a torque of the pulling force is greater than a torque of the attraction force between the plurality of first magnets and the plurality of second magnets.

8. The protection case of claim 6, wherein the cord coiling device further comprises a driving gear and a transmission gear, both the driving gear and the transmission gear are rotatablely fixed on the fixing pillar, the driving gear rotates under a driving force of a motor, and the transmission gear is fixed between the driving gear and the deceleration gear to transmit the driving force to the deceleration gear.

9. The protection case of claim 6, wherein a plurality of circle shaped metal pieces are arranged on a second bottom side corresponding to the first bottom side of the body, an end of the headphone cord is coupled to the headphone, and the other end is coupled to the plurality of metal pieces.

10. The protection case of claim 9, wherein the cord coiling device further comprises a plurality of signal poles, an end of each signal pole is slidably coupled to one of the plurality of metal pieces, the other end of each signal pole is coupled to an audio signal source.

11. The protection of claim 6, wherein the protection case further comprises an accommodation groove for accommodating the headphone and part of the headphone cord which is pulled out from the cord coiling device.
